(19) United States
(12) Patent Application Publication
(10) Pub. No.: US 2008/0086638 A1
(43) Pub. Date: Apr. 10, 2008

(54) BROWSER REPUTATION INDICATORS WITH TWO-WAY AUTHENTICATION

(75) Inventor: Laura Mather, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MarkMonitor Inc., Boise, ID (US)

(21) Appl. No.: 11/539,357

(22) Filed: Oct. 6, 2006

(51) Int. Cl. H04L 9/32; H04L 9/00; G06K 9/00; G06F 17/30; G06F 7/04

(52) U.S. Cl. 713/168; 726/2

(57) ABSTRACT

Embodiments of the invention provide systems and methods for preventing online fraud. According to one embodiment, a method for providing an indication of the legitimacy of a web page can comprise receiving the web page. A determination can be made as to whether the web page is legitimate based, for example, on a reputation of the web page. In response to determining the web page is legitimate, at least one positive indicator can be displayed on a browser window for displaying the web page. This positive indicator can be user-selected such that the user can be confident that the browser or computer-based software knows the identity of the current user. According to one embodiment, the indication can be displayed on a portion of the browser window or the desktop portion of the user's computer that is not accessible to code of the web page.

### CROSS-REFERENCES TO RELATED APPLICATIONS

This application is related to the following commonly-owned, co-pending applications (the “Related Applications”), of which the entire disclosure of each is incorporated herein by reference, as if set forth in full in this document, for all purposes:

U.S. patent application Ser. No. 11/428,072 filed Jun. 30, 2006 by Shull et al and entitled “Enhanced Fraud Monitoring Systems”; U.S. patent application Ser. No. 10/709,398 filed May 2, 2004 by Shraim et al. and entitled “Online Fraud Solution”; U.S. Prov. App. No. 60/615,973, filed Oct. 4, 2004 by Shraim et al. and entitled “Online Fraud Solution”; U.S. Prov. App. No. 60/610,716, filed Sep. 17, 2004 by Shull and entitled “Methods and Systems for Preventing Online Fraud”; U.S. Prov. App. No., 60, 610,715, filed Sep. 17, 2004 by Shull et al. and entitled “Customer-Based Detection of Online Fraud”; U.S. patent application Ser. No. 10/996,991, filed Nov. 23, 2004 by Shraim et al. and entitled “Online Fraud Solution”; U.S. patent application Ser. No. 10/996,567, filed Nov. 23, 2004 by Shraim et al. and entitled “Enhanced Responses to Online Fraud”; U.S. patent application Ser. No. 10/996,990, filed Nov. 23, 2004 by Shraim et al. and entitled “Customer-Based Detection of Online Fraud”; U.S. patent application Ser. No. 10/996,566, filed Nov. 23, 2004 by Shraim et al. and entitled “Early Detection and Monitoring of Online Fraud”; U.S. patent application Ser. No. 10/996,646, filed Nov. 23, 2004 by Shraim et al. and entitled “Enhanced Responses to Online Fraud”; U.S. patent application Ser. No. 10/996,568, filed Nov. 23, 2004 by Shraim et al. and entitled “Generating Phish Messages”; U.S. patent application Ser. No. 10/997,626, filed Nov. 23, 2004 by Shraim et al. and entitled “Methods and Systems for Analyzing Data Related to Possible Online Fraud”; U.S. Prov. App. No. 60/658,124, filed Mar. 2, 2005 by Shull et al. and entitled “Distribution of Trust Data”; U.S. Prov. App. No. 60/658,087, filed Mar. 2, 2005 by Shull et al. and, entitled “Trust Evaluation System and Methods”; and U.S. Prov. App. No. 60/658,281, filed Mar. 2, 2005 by Shull et al. and entitled “Implementing Trust Policies.”

### BACKGROUND OF THE INVENTION

Embodiments of the present invention relate generally to preventing online fraud. More specifically, embodiments of the present invention relate to methods and systems for browser-based or other indicators to indicate a trusted web page.

The problem of online fraud, including without limitation the technique of “phishing,” and other illegitimate online activities, have become a common problem for Internet users and those who wish to do business with them. Internet browser programs are attempting to incorporate browser-based indicators when a site is suspected to be fraudulent. For example, Internet Explorer® 7.0 by Microsoft® Corporation incorporates a Phishing Filter that warns the user when they browse to a site that is known to be a Phishing site. That is, the browser displays, in the portion of the browser window where the web page normally appears, a warning or cautionary message when a web page is determined to be associated with fraudulent activity. The user is then given options to continue on and view the web page or to leave the web page.

Security experts argue that it is not enough to have the user authenticate to a particular website. In addition, it is important for the website to authenticate itself to the user. This creates a second direction of authentication that empowers the user to assure him or herself that a site that requests sensitive information is legitimate. Although there are some web page methods for performing two-way authentication, there are currently no browser-imbedded or implemented methods using two-way authentication of the user and the website.

Hence, there is a need in the art for improved non-web-page-based indicators of a web page's legitimacy that can include the notion of two-way authentication to increase the level of web page security indicators by making it more difficult for Phishers to replicate legitimate web pages on malicious sites.

### BRIEF SUMMARY OF THE INVENTION

Embodiments of the invention provide systems and methods for non-web-page-based authentication of legitimate web pages. For example, the web browser can display an indication of two-way authentication in the “chrome” or other portion of the browser window that is not accessible to the code of the web page that validates to the user that the web site is legitimate. In another embodiment, this two-way authentication can be performed by software that resides on the user's machine and notifies the user via an indication on the browser window or elsewhere on the user interface when they navigate to a legitimate site with their web browser. According to one embodiment, the user can select different indicators for each of a set of legitimate web sites that they want to authenticate. By selecting a different indicator per web site, the user can receive an indication that, not only are they on a legitimate site, but they are on the legitimate site they are expecting.

According to one embodiment, a method for providing a browser-based indication of legitimacy of a web page can comprise receiving the web page. A determination can be made as to whether the web page is legitimate. According to one embodiment, determining whether the web page is legitimate can be based on authenticating a source of the web page. Additionally or alternatively, determining whether the web page is legitimate can be based on reputation of the web page.

In response to determining the web page is legitimate, at least one positive indicator can be displayed on a browser window for displaying the web page. In such a case, the method can further comprise displaying as least one negative indicator on the browser window. Displaying the at least one positive indicator on the browser window can comprise displaying the at least one positive indicator in a portion of the browser window that cannot be modified by the web page. Additionally or alternatively, in response to determining the web page is related to possible fraudulent activity or is not legitimate, the positive indicator, if any, can be removed from the browser window.

According to one embodiment, the method can further comprise presenting a plurality of options for the at least one positive indicator during a setup process for the browser or the client-based software. A selection of one or more of the plurality of options can be received and stored. The plurality of options can include, for example, a plurality of pre-defined indicators. In such a case, receiving a selection of one or more indicators can comprise receiving a selection of one or more of the pre-defined indicators. In another example, the plurality of options can include an option for specifying one or more user-defined indicators. In such a case, receiving a selection of one or more indicators can comprise receiving an indication of one or more user-defined indicators. In yet another example, the plurality of options can include both a plurality of pre-defined indicators and an option for specifying one or more user-defined indicators. In such a case, receiving a selection of one or more indicators can comprise receiving a selection of one or more of the pre-defined indicators and receiving an indication of one or more user-defined indicators.

This selection by the user can be used to notify the user when they navigate to a legitimate web page via a web browser. For example, either the web browser or a client installed on the user's computer can notify the user that they are on a legitimate web page and that the browser or client knows which user is navigating to the site since the client-selected image is shown upon navigation to this legitimate page. This makes it difficult for the person perpetrating the phishing act to pretend to be a legitimate page since it will be difficult to have the browser or client-based software display the pre-selected image.

According to another embodiment, a system can comprise a processor and a memory communicatively coupled with and readable by the processor. The memory can have stored therein a series of instructions which, when executed by the processor, cause the processor to receive a web page, determine whether the web page is legitimate, and in response to determining the web page is legitimate, display at least one positive indicator on a browser window or somewhere on the user's computer desktop for displaying the web page.

According to still another embodiment, a machine-readable medium can have stored thereon a series of executable instructions that, when executed by a processor, cause the processor to provide a browser-based indication of possible fraudulent activity related to a web page by receiving the web page. A determination can be made as to whether the web page is legitimate. In response to determining the web page is legitimate, at least one positive indicator can be on a browser window or somewhere on the user's computer desktop for displaying the web page.

### BRIEF DESCRIPTION OF THE DRAWINGS

FIG. 1A is a functional diagram illustrating a system for combating online fraud, in accordance with various embodiments of the invention.

FIG. 1B is a functional diagram illustrating a system for planting bait email addresses, in accordance with various embodiments of the invention.

FIG. 2 is a schematic diagram illustrating a system for combating online fraud, in accordance with various embodiments of the invention.

FIG. 3 is a generalized schematic diagram of a computer that may be implemented in a system for combating online fraud, in accordance with various embodiments of the invention.

FIG. 4 is a flowchart illustrating a process for selecting one or more indicators according to one embodiment of the present invention.

FIG. 5 is a flowchart illustrating a process for providing one or more indicators according to one embodiment of the present invention.

FIG. 6 is an exemplary screenshot of a web browser displaying an indicator of the legitimacy of a web page according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Generally speaking, embodiments of the present invention provide for displaying one or more indicators to the user based on the reputation of a website or other information indicating the relative safety or potential for fraudulent activity related to the site. According to one embodiment, when a user installs a browser, upgrades to a browser that supports browser-based indicators, or otherwise performs a set-up function, such as setting user preferences etc., the browser or another application on the user's computer can prompt the user to select from a set of indicators for each of one or more types of reputation. For example, the user can be prompted to select an image from a set of pre-defined images or specify user-defined images that correspond to states such as “safe,” “unknown,” and “known fraud.” By allowing the user to select an indicator, either from a set of pre-defined possible indicators or by specifying one or more user-defined indicators, rather than using a default image or images, security is improved since a Phisher, fraudster, or other bad actor is less likely or unable to guess the indicator used by a particular user and then mimic that indicator on a web page in an attempt to trick the user into believing a site is safe.

Once the image(s) or other indications for each reputation type have been selected by the user, the browser or other application can display the appropriate image for a currently viewed web page in a portion of the browser not accessible or alterable by a web page being displayed, e.g., on the “chrome” of the browser. Based on such an indication, the user can quickly deduce the type of site that they are on and know that the reputation has been confirmed by their particular browser since it is displaying their selected image.

In accordance with various embodiments, systems, methods and software are provided for combating online fraud, and specifically “phishing” operations. An exemplary phishing operation, known as a “spoofing” scam, uses “spoofed” email messages to induce unsuspecting consumers into accessing an illicit web site and providing personal information to a server believed to be operated by a trusted affiliate (such as a bank, online retailer, etc.), when in fact the server is operated by another party masquerading as the trusted affiliate in order to gain access to the consumers' personal information. As used herein, the term “personal information” should be understood to include any information that could be used to identify a person and/or normally would be revealed by that person only to a relatively trusted entity. Merely by way of example, personal information can include, without limitation, a financial institution account number, credit card number, expiration date and/or security code (sometimes referred to in the art as a “Card Verification Number,” “Card Verification Value,” “Card Verification Code” or “CVV”), and/or other financial information; a userid, password, mother's maiden name, and/or other security information; a full name, address, phone number, social security number, driver's license number, and/or other identifying information.

Embodiments of the present invention provide indicators of a web page's legitimacy that, according to one embodiment, may be based in whole or in part on a reputation of that web page. Such reputation may be determined based on information from a fraud monitoring service such as described in the related applications referenced above. A summary of such a system is presented herein for convenience. However, it should be noted that the discussion of this system is provided only to facilitate an understanding of one possible implementation and various embodiments are not limited to use with such a system.

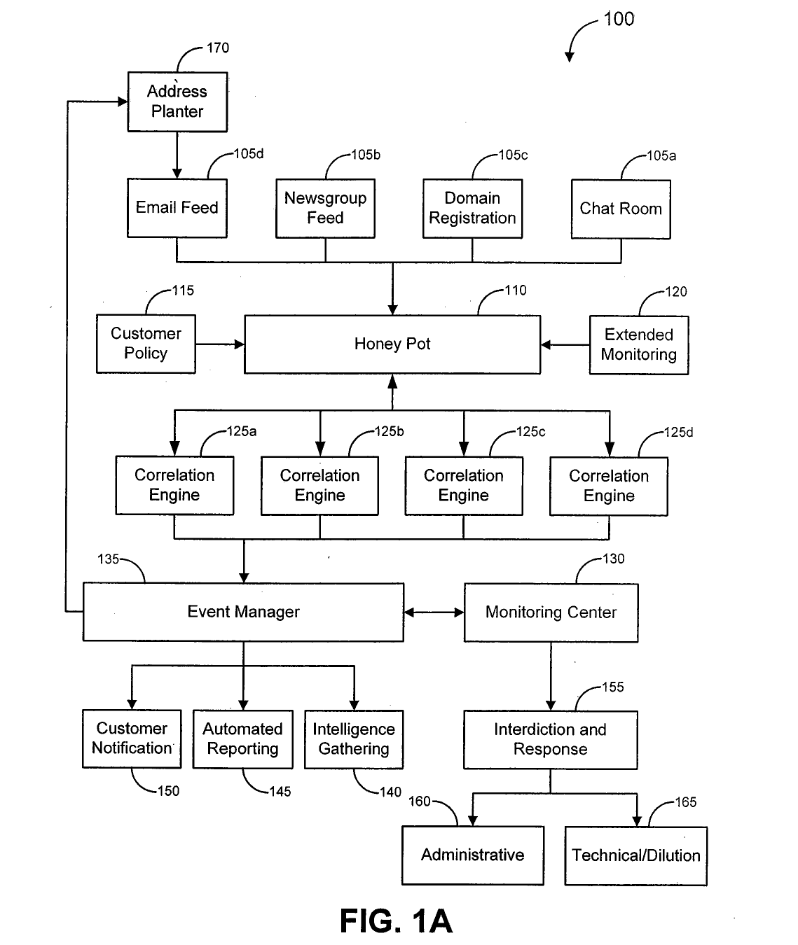

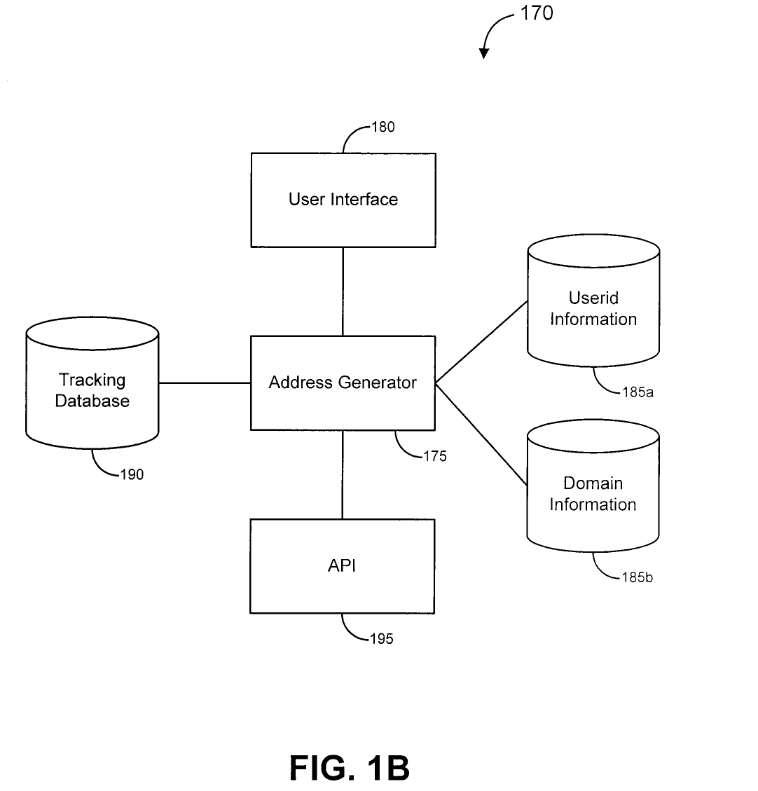

FIG. 1A illustrates the functional elements of an exemplary system 100 that can be used to combat online fraud in accordance with some of these embodiments and provides a general overview of how certain embodiments can operate. (Various embodiments will be discussed in additional detail below). It should be noted that the functional architecture depicted by FIG. 1A and the procedures described with respect to each functional component are provided for purposes of illustration only, and that embodiments of the invention are not necessarily limited to a particular functional or structural architecture; the various procedures discussed herein may be performed in any suitable framework.

In many cases, the system 100 of FIG. 1A may be operated by a fraud prevention service, security service, etc. (referred to herein as a “fraud prevention provider”) for one or more customers. Often, the customers will be entities with products, brands and/or web sites that risk being imitated, counterfeited and/or spoofed, such as online merchants, financial institutions, businesses, etc. In other cases, however, the fraud prevention provider may be an employee of the customer an/or an entity affiliated with and/or incorporated within the customer, such as the customer's security department, information services department, etc.

In accordance with some embodiments, of the invention, the system 100 can include (and/or have access to) a variety of data sources 105. Although the data sources 105 are depicted, for ease of illustration, as part of system 100, those skilled in the art will appreciate, based on the disclosure herein, that the data sources 105 often are maintained independently by third parties and/or may be accessed by the system 100. In some cases, certain of the data sources 105 may be mirrored and/or copied locally (as appropriate), e.g., for easier access by the system 100.

The data sources 105 can comprise any source from which data about a possible online fraud may be obtained, including, without limitation, one or more chat rooms 105a, newsgroup feeds 105b, domain registration files 105c, and/or email feeds 105d. The system 100 can use information obtained from any of the data sources 105 to detect an instance of online fraud and/or to enhance the efficiency and/or effectiveness of the fraud prevention methodology discussed herein. In some cases, the system 100 (and/or components thereof) can be configured to “crawl” (e.g., to automatically access and/or download information from) various of the data sources 105 to find pertinent information, perhaps on a scheduled basis (e.g., once every 10 minutes, once per day, once per week, etc.).

Merely by way of example, there are several newsgroups commonly used to discuss new spamming/spoofing schemes, as well as to trade lists of harvested email addresses. There are also anti-abuse newsgroups that track such schemes. The system 100 may be configured to crawl any applicable newsgroup(s) 105b to find information about new spoof scams, new lists of harvested addresses, new sources for harvested addresses, etc. In some cases, the system 100 may be configured to search for specified keywords (such as “phish,” “spoof,” etc.) in such crawling. In other cases, newsgroups may be scanned for URLs, which may be download (or copied) and subjected to further analysis, for instance, as described in detail below. In addition, as noted above, there may be one or more anti-abuse groups that can be monitored. Such anti-abuse newsgroups often list new scams that have been discovered and/or provide URLs for such scams. Thus, such anti-abuse groups may be monitored/crawled, e.g., in the way described above, to find relevant information, which may then be subjected to further analysis. Any other data source (including, for example, web pages and/or entire web sites, email messages, etc.) may be crawled and/or searched in a similar manner.

As another example, online chat rooms (including without limitation, Internet Relay Chat (“IRC”) channels, chat rooms maintained/hosted by various ISPs, such as Yahoo, America Online, etc., and/or the like) (e.g., 105a) may be monitored (and/or logs from such chat rooms may be crawled) for pertinent information. In some cases, an automated process (known in the art as a “bot”) may be used for this purpose. In other cases, however, a human attendant may monitor such chat rooms personally. Those skilled in the art will appreciate that often such chat rooms require participation to maintain access privileges. In some cases, therefore, either a bot or a human attendant may post entries to such chat rooms in order to be seen as a contributor.

Domain registration zone files 105c (and/or any other sources of domain and/or network information, such as Internet registry e.g., ARIN) may also be used as data sources. As those skilled in the art will appreciate, zone files are updated periodically (e.g., hourly or daily) to reflect new domain registrations. These files may be crawled/scanned periodically to look for new domain registrations. In particular embodiments, a zone file 105c may be scanned for registrations similar to a customer's name and/or domain. Merely by way of example, the system 100 can be configured to search for similar domains registration with a different top level domain (“TLD”) or global top level domain (“gTLD”), and/or a domains with similar spellings. Thus, if a customer uses the <acmeproducts.com> domain, the registration of <acmeproducts.biz>, <acmeproducts.co.uk>, and/or <acmeproduct.com> might be of interest as potential hosts for spoof sites, and domain registrations for such domains could be downloaded and/or noted, for further analysis of the domains to which the registrations correspond. In some embodiments, if a suspicious domain is found, that domain may be placed on a monitoring list. Domains on the monitoring list may be monitored periodically, as described in further detail below, to determine whether the domain has become “live” (e.g., whether there is an accessible web page associated with the domain).

One or more email feeds 105d can provide additional data sources for the system 100. An email feed can be any source of email messages, including spam messages, as described above. (Indeed, a single incoming email message may be considered an email feed in accordance with some embodiments.) In some cases, for instance as described in more detail below, bait email addresses may be “seeded” or planted by embodiments of the invention, and/or these planted addresses can provide a source of email (i.e., an email feed). The system 100, therefore, can include an address planter 170, which is shown in detail with respect to FIG. 1B.

The address planter 170 can include an email address generator 175. The address generator 175 can be in communication with a user interface 180 and/or one or more databases 185 (each of which may comprise a relational database and/or any other suitable storage mechanism). One such data store may comprise a database of userid information 185a. The userid information 185a can include a list of names, numbers and/or other identifiers that can be used to generate userids in accordance with embodiments of the invention. In some cases, the userid information 185a may be categorized (e.g., into first names, last names, modifiers, such as numbers or other characters, etc.). Another data store may comprise domain information 180. The database of domain information 180 may include a list of domains available for addresses. In many cases, these domains will be domains that are owned/managed by the operator of the address planter 170. In other cases, however, the domains might be managed by others, such as commercial and/or consumer ISPs, etc.

The address generator 175 comprises an address generation engine, which can be configured to generate (on an individual and/or batch basis) email addresses that can be planted at appropriate locations on the Internet (or elsewhere). Merely by way of example, the address generator 175 may be configured to select one or more elements of userid information from the userid data store 185a (and/or to combine a plurality of such elements), and append to those elements a domain selected from the domain data store 185b, thereby creating an email address. The procedure for combining these components is discretionary. Merely by way of example, in some embodiments, the address generator 175 can be configured to prioritize certain domain names, such that relatively more addresses will be generated for those domains. In other embodiments, the process might comprise a random selection of one or more address components.

Some embodiments of the address planter 170 include a tracking database 190, which can be used to track planting operations, including without limitation the location (e.g., web site, etc.) at which a particular address is planted, the date/time of the planting, as well as any other pertinent detail about the planting. Merely by way of example, if an address is planted by subscribing to a mailing list with a given address, the mailing list (as well, perhaps, as the web site, list maintainer's email address, etc.) can be documented in the tracking database. In some cases, the tracking of this information can be automated (e.g., if the address planter's 170 user interface 180 includes a web browser and/or email client, and that web browser/email client is used to plant the address, information about the planting information may be automatically registered by the address planter 170). Alternatively, a user may plant an address manually (e.g., using her own web browser, email client, etc.), and therefore may add pertinent information to the tracking database via a dedicated input window, web browser, etc.

In one set of embodiments, therefore, the address planter 170 may be used to generate an email address, plant an email address (whether or not generated by the address planter 170) in a specified location and/or track information about the planting operation. In particular embodiments, the address planter 170 may also include one or more application programming interfaces (“API”) 195, which can allow other components of the system 100 of FIG. 1 (or any other appropriate system) to interact programmatically with the address planter. Merely by way of example, in some embodiments, an API 195 can allow the address planter 170 to interface with a web browser, email client, etc. to perform planting operations. (In other embodiments, as described above, such functionality may be included in the address planter 170 itself).

A particular use of the API 195 in certain embodiments is to allow other system components (including, in particular, the event manager 135) to obtain and/or update information about address planting operations (and/or their results). (In some cases, programmatic access to the address planter 170 may not be needed—the necessary components of the system 100 can merely have access—via SQL, etc.—one or more of the data stores 185, as needed.) Merely by way of example, if an email message is analyzed by the system 100 (e.g., as described in detail below), the system 100 may interrogate the address planter 170 and/or one or more of the data stores 185 to determine whether the email message was addressed to an address planted by the address planter 170. If so, the address planter 170 (or some other component of the system 100, such as the event manager 135), may note the planting location as a location likely to provoke phish messages, so that additional addresses may be planted in such a location, as desired. In this way, the system 100 can implement a feedback loop to enhance the efficiency of planting operations. (Note that this feedback process can be implemented for any desired type of “unsolicited” message, including without limitation phish messages, generic spam messages, messages evidencing trademark misuse, etc.).

Other email feeds are described elsewhere herein, and they can include (but are not limited to), messages received directly from spammers/phishers; email forwarded from users, ISPs and/or any other source (based, perhaps, on a suspicion that the email is a spam and/or phish); email forwarded from mailing lists (including without limitation anti-abuse mailing lists), etc. When an email message (which might be a spam message) is received by the system 100, that message can be analyzed to determine whether it is part of a phishing/spoofing scheme. The analysis of information received from any of these data feeds is described in further detail below, and it often includes an evaluation of whether a web site (often referenced by a URL or other information received/downloaded from a data source 105) is likely to be engaged in a phishing and/or spoofing scam.

Any email message incoming to the system can be analyzed according to various methods of the invention. As those skilled in the art will appreciate, there is a vast quantity of unsolicited email traffic on the Internet, and many of those messages may be of interest in the online fraud context. Merely by way of example, some email messages may be transmitted as part of a phishing scam, described in more detail herein. Other messages may solicit customers for black- and/or grey-market goods, such as pirated software, counterfeit designer items (including without limitation watches, handbags, etc.). Still other messages may be advertisements for legitimate goods, but may comprise unlawful or otherwise forbidden (e.g., by contract) practices, such as improper trademark use and/or infringement, deliberate under-pricing of goods, etc. Various embodiments of the invention can be configured to search for, identify and/or respond to one or more of these practices, as detailed below. (It should be noted as well that certain embodiments may be configured to access, monitor, crawl, etc. data sources—including zone files, web sites, chat rooms, etc.—other than email feeds for similar conduct). Merely by way of example, the system 100 could be configured to scan one or more data sources for the term ROLEX, and/or identify any improper advertisements for ROLEX watches.

Those skilled in the art will further appreciate that an average email address will receive many unsolicited email messages, and the system 100 may be configured, as described below, to receive and/or analyze such messages. Incoming messages may be received in many ways. Merely by way of example, some messages might be received “randomly,” in that no action is taken to prompt the messages. Alternatively, one or more users may forward such messages to the system. Merely by way of example, an ISP might instruct its users to forward all unsolicited messages to a particular address, which could be monitored by the system 100, as described below, or might automatically forward copies of users' incoming messages to such an address. In particular embodiments, an ISP might forward suspicious messages transmitted to its users (and/or parts of such suspicious messages, including, for example, any URLs included in such messages) to the system 100 (and/or any appropriate component thereof) on a periodic basis. In some cases, the ISP might have a filtering system designed to facilitate this process, and/or certain features of the system 100 might be implemented (and/or duplicated) within the ISP's system.

As described above, the system 100 can also plant or “seed” bait email addresses (and/or other bait information) in certain of the data sources, e.g. for harvesting by spammers/phishers. In general, these bait email addresses are designed to offer an attractive target to a harvester of email addresses, and the bait email addresses usually (but not always) will be generated specifically for the purpose of attracting phishers and therefore will not be used for normal email correspondence.

Returning to FIG. 1A, therefore, the system 100 can further include a “honey pot” 110. The honey pot 110 can be used to receive information from each of the data sources 105 and/or to correlate that information for further analysis if needed. The honey pot 110 can receive such information in a variety of ways, according to various embodiments of the invention, and how the honey pot 110 receives the information is discretionary.

Merely by way of example, the honey pot 100 may, but need not, be used to do the actual crawling/monitoring of the data sources, as described above. (In some cases, one or more other computers/programs may be used to do the actual crawling/monitoring operations and/or may transmit to the honey pot 110 any relevant information obtained through such operations. For instance, a process might be configured to monitor zone files and transmit to the honey pot 110 for analysis any new, lapsed and/or otherwise modified domain registrations. Alternatively, a zone file can be fed as input to the honey pot 110, and/or the honey pot 110 can be used to search for any modified domain registrations.) The honey pot 110 may also be configured to receive email messages (which might be forwarded from another recipient) and/or to monitor one or more bait email addresses for incoming email. In particular embodiments, the system 100 may be configured such that the honey pot 110 is the mail server for one or more email addresses (which may be bait addresses), so that all mail addressed to such addresses is sent directly to the honey pot 110. The honey pot 110, therefore, can comprise a device and/or software that functions to receive email messages (such as an SMTP server, etc.) and/or retrieve email messages (such as a POP3 and/or IMAP client, etc.) addressed to the bait email addresses. Such devices and software are well-known in the art and need not be discussed in detail herein. In accordance with various embodiments, the honey pot 110 can be configured to receive any (or all) of a variety of well-known message formats, including SMTP, MIME, HTML, RTF, SMS and/or the like. The honey pot 110 may also comprise one or more databases (and/or other data structures), which can be used to hold/categorize information obtained from email messages and other data (such as zone files, etc.), as well as from crawling/monitoring operations.

In some aspects, the honey pot 110 might be configured to do some preliminary categorization and/or filtration of received data (including without limitation received email messages). In particular embodiments, for example, the honey pot 110 can be configured to search received data for “blacklisted” words or phrases. (The concept of a “blacklist” is described in further detail below). The honey pot 110 can segregate data/messages containing such blacklisted terms for prioritized processing, etc. and/or filter data/messages based on these or other criteria.

The honey pot 110 also may be configured to operate in accordance with a customer policy 115. An exemplary customer policy might instruct the honey pot to watch for certain types and/or formats of emails, including, for instance, to search for certain keywords, allowing for customization on a customer-by-customer basis. In addition, the honey pot 110 may utilize extended monitoring options 120, including monitoring for other conditions, such as monitoring a customer's web site for compromises, etc. The honey pot 110, upon receiving a message, optionally can convert the email message into a data file.

In some embodiments, the honey pot 110 will be in communication with one or more correlation engines 125, which can perform a more detailed analysis of the email messages (and/or other information/data, such as information received from crawling/monitoring operations) received by the honey pot 110. (It should be noted, however, that the assignment of functions herein to various components, such as honey pots 110, correlation engines 125, etc. is arbitrary, and in accordance with some embodiments, certain components may embody the functionality ascribed to other components.)

On a periodic basis and/or as incoming messages/information are received/retrieved by the honey pot 110, the honey pot 110 will transmit the received/retrieved email messages (and/or corresponding data files) to an available correlation engine 125 for analysis. Alternatively, each correlation engine 125 may be configured to periodically retrieve messages/data files from the honey pot 110 (e.g., using a scheduled FTP process, etc.). For example, in certain implementations, the honey pot 110 may store email messages and/or other data (which may or may not be categorized/filtered), as described above, and each correlation engine may retrieve data an/or messages on a periodic and/or ad hoc basis. For instance, when a correlation engine 125 has available processing capacity (e.g., it has finished processing any data/messages in its queue), it might download the next one hundred messages, data files, etc. from the honeypot 110 for processing. In accordance with certain embodiments, various correlation engines (e.g., 125a, 125b, 125c, 125d) may be specifically configured to process certain types of data (e.g., domain registrations, email, etc.). In other embodiments, all correlation engines 125 may be configured to process any available data, and/or the plurality of correlation engines (e.g., 125a, 125b, 125c, 125d) can be implemented to take advantage of the enhanced efficiency of parallel processing.

The correlation engine(s) 125 can analyze the data (including, merely by way of example, email messages) to determine whether any of the messages received by the honey pot 110 are phish messages and/or are likely to evidence a fraudulent attempt to collect personal information. Procedures for performing this analysis are described in detail below.

The correlation engine 125 can be in communication an event manager 135, which may also be in communication with a monitoring center 130. (Alternatively, the correlation engine 125 may also be in direct communication with the monitoring center 130.) In particular embodiments, the event manager 135 may be a computer and/or software application, which can be accessible by a technician in the monitoring center 130. If the correlation engine 125 determines that a particular incoming email message is a likely candidate for fraudulent activity or that information obtained through crawling/monitoring operations may indicate fraudulent activity, the correlation engine 125 can signal to the event manager 135 that an event should be created for the email message. In particular embodiments, the correlation engine 125 and/or event manager 135 can be configured to communicate using the Simple Network Management (“SNMP”) protocol well known in the art, and the correlation engine's signal can comprise an SNMP “trap” indicating that analyzed message(s) and/or data have indicated a possible fraudulent event that should be investigated further. In response to the signal (e.g., SNMP trap), the event manager 135 can create an event (which may comprise an SNMP event or may be of a proprietary format).

Upon the creation of an event, the event manager 135 can commence an intelligence gathering operation (investigation) 140 of the message/information and/or any URLs included in and/or associated with message/information. As described in detail below, the investigation can include gathering information about the domain and/or IP address associated with the URLs, as well as interrogating the server(s) hosting the resources (e.g., web page, etc.) referenced by the URLs. (As used herein, the term “server” is sometimes used, as the context indicates, any computer system that is capable of offering IP-based services or conducting online transactions in which personal information may be exchanged, and specifically a computer system that may be engaged in the fraudulent collection of personal information, such as by serving web pages that request personal information. The most common example of such a server, therefore, is a web server that operates using the hypertext transfer protocol (“HTTP”) and/or any of several related services, although in some cases, servers may provide other services, such as database services, etc.). In certain embodiments, if a single email message (or information file) includes multiple URLs, a separate event may be created for each URL; in other cases, a single event may cover all of the URLs in a particular message. If the message and/or investigation indicates that the event relates to a particular customer, the event may be associated with that customer.

The event manager can also prepare an automated report 145 (and/or cause another process, such as a reporting module (not shown) to generate a report), which may be analyzed by an additional technician at the monitoring center 130 (or any other location, for that matter), for the event; the report can include a summary of the investigation and/or any information obtained by the investigation. In some embodiments, the process may be completely automated, so that no human analysis is necessary. If desired (and perhaps as indicated by the customer policy 115), the event manager 135 can automatically create a customer notification 150 informing the affected customer of the event. The customer notification 150 can comprise some (or all) of the information from the report 145. Alternatively, the customer notification 150 can merely notify the customer of an event (e.g., via email, telephone, pager, etc.) allowing a customer to access a copy of the report (e.g., via a web browser, client application, etc.). Customers may also view events of interest to the using a portal, such as a dedicated web site that shows events involving that customer (e.g., where the event involves a fraud using the customer's trademarks, products, business identity, etc.).

If the investigation 140 reveals that the server referenced by the URL is involved in a fraudulent attempt to collect personal information, the technician may initiate an interdiction response 155 (also referred to herein as a “technical response”). (Alternatively, the event manager 135 could be configured to initiate a response automatically without intervention by the technician). Depending on the circumstances and the embodiment, a variety of responses could be appropriate. For instance, those skilled in the art will recognize that in some cases, a server can be compromised (i.e., “hacked”), in which case the server is executing applications and/or providing services not under the control of the operator of the server. (As used in this context, the term “operator” means an entity that owns, maintains and/or otherwise is responsible for the server.) If the investigation 140 reveals that the server appears to be compromised, such that the operator of the server is merely an unwitting victim and not a participant in the fraudulent scheme, the appropriate response could simply comprise informing the operator of the server that the server has been compromised, and perhaps explaining how to repair any vulnerabilities that allowed the compromise.

In other cases, other responses may be more appropriate. Such responses can be classified generally as either administrative 160 or technical 165 in nature, as described more fully below. In some cases, the system 100 may include a dilution engine (not shown), which can be used to undertake technical responses, as described more fully below. In some embodiments, the dilution engine may be a software application running on a computer and configured, inter alia, to create and/or format responses to a phishing scam, in accordance with methods of the invention. The dilution engine may reside on the same computer as (and/or be incorporated in) a correlation engine 125, event manager 135, etc. and/or may reside on a separate computer, which may be in communication with any of these components.

As described above, in some embodiments, the system 100 may incorporate a feedback process, to facilitate a determination of which planting locations/techniques are relatively more effective at generating spam. Merely by way of example, the system 100 can include an address planter 170, which may provide a mechanism for tracking information about planted addresses, as described above. Correspondingly, the event manager 135 may be configured to analyze an email message (and particular, a message resulting in an event) to determine if the message resulted from a planting operation. For instance, the addressees of the message may be evaluated to determine which, if any, correspond to one or more address(es) planted by the system 100. If it is determined that the message does correspond to one or more planted addresses, a database of planted addresses may be consulted to determine the circumstances of the planting, and the system 100 might display this information for a technician. In this way, a technician could choose to plant additional addresses in fruitful locations. Alternatively, the system 100 could be configured to provide automatic feedback to the address planter 170, which in turn could be configured to automatically plant additional addresses in such locations.

In accordance with various embodiments of the invention, therefore, a set of data about a possible online fraud (which may be an email message, domain registration, URL, and/or any other relevant data about an online fraud) may be received and analyzed to determine the existence of a fraudulent activity, an example of which may be a phishing scheme. As used herein, the term “phishing” means a fraudulent scheme to induce a user to take an action that the user would not otherwise take, such as provide his or her personal information, buy illegitimate products, etc., often by sending unsolicited email message (or some other communication, such as a telephone call, web page, SMS message, etc.) requesting that the user access an server, such as a web server, which may appear to be legitimate. If so, any relevant email message, URL, web site, etc. may be investigated, and/or responsive action may be taken. Additional features and other embodiments are discussed in further detail below.

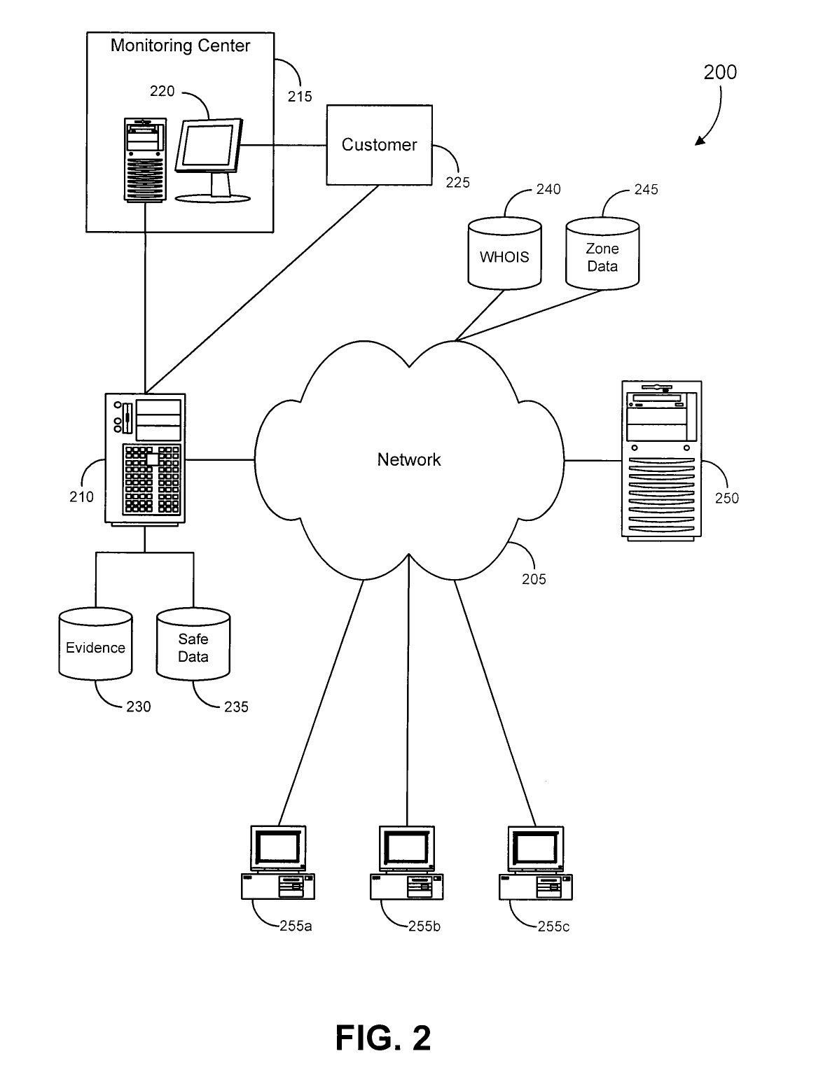

As noted above, certain embodiments of the invention provide systems for dealing with online fraud. The system 200 of FIG. 2 can be considered exemplary of one set of embodiments. The system 200 generally runs in a networked environment, which can include a network 205. In many cases, the network 205 will be the Internet, although in some embodiments, the network 205 may be some other public and/or private network. In general, any network capable of supporting data communications between computers will suffice. The system 200 includes a master computer 210, which can be used to perform any of the procedures or methods discussed herein. In particular, the master computer 210 can be configured (e.g., via a software application) to crawl/monitor various data sources, seed bait email addresses, gather and/or analyze email messages transmitted to the bait email addresses, create and/or track events, investigate URLs and/or servers, prepare reports about events, notify customers about events, and/or communicate with a monitoring center 215 (and, more particularly, with a monitoring computer 220 within the monitoring center) e.g. via a telecommunication link. The master computer 210 may be a plurality of computers, and each of the plurality of computers may be configured to perform specific processes in accordance with various embodiments. Merely by way of example, one computer may be configured to perform the functions described above with respect to a honey pot, another computer may be configured to execute software associated with a correlation engine, e.g. performing the analysis of email messages/data files; a third computer may be configured to serve as an event manager, e.g., investigating and/or responding to incidents of suspected fraud, and/or a fourth computer may be configured to act as a dilution engine, e.g., to generate and/or transmit a technical response, which may comprise, merely by way of example, one or more HTTP requests, as described in further detail below. Likewise, the monitoring computer 220 may be configured to perform any appropriate functions.

The monitoring center 215, the monitoring computer 220, and/or the master computer 210 may be in communication with one or more customers 225 e.g., via a telecommunication link, which can comprise connection via any medium capable of providing voice and/or data communication, such as a telephone line, wireless connection, wide area network, local area network, virtual private network, and/or the like. Such communications may be data communications and/or voice communications (e.g., a technician at the monitoring center can conduct telephone communications with a person at the customer). Communications with the customer(s) 225 can include transmission of an event report, notification of an event, and/or consultation with respect to responses to fraudulent activities. According to one embodiment of the present invention, communications between the customer(s) 225 and the monitoring center 215 can comprise a web browser of the customer computer requesting fraud information regarding a requested or viewed page in order to determine whether fraudulent activity is associated with that page. Based on such information, the web browser of the customer computer can select and display an appropriate indication as will be discussed in detail below.

The master computer 210 can include (and/or be in communication with) a plurality of data sources, including without limitation the data sources 105 described above. Other data sources may be used as well. For example, the master computer can comprise an evidence database 230 and/or a database of “safe data,” 235, which can be used to generate and/or store bait email addresses and/or personal information for one or more fictitious (or real) identities, for use as discussed in detail below. (As used herein, the term “database” should be interpreted broadly to include any means of storing data, including traditional database management software, operating system file systems, and/or the like.) The master computer 210 can also be in communication with one or more sources of information about the Internet and/or any servers to be investigated. Such sources of information can include a domain WHOIS database 240, zone data file 245, etc. Those skilled in the art will appreciate that WHOIS databases often are maintained by central registration authorities (e.g., the American Registry for Internet Numbers (“ARIN”), Network Solutions, Inc., etc), and the master computer 210 can be configured to query those authorities; alternatively, the master computer 210 could be configured to obtain such information from other sources, such as privately-maintained databases, etc. The master computer 210 (and/or any other appropriate system component) may use these resources, and others, such as publicly-available domain name server (DNS) data, routing data and/or the like, to investigate a server 250 suspected of conducting fraudulent activities. As noted above, the server 250 can be any computer capable of processing online transactions, serving web pages and/or otherwise collecting personal information.

The system can also include one or more response computers 255, which can be used to provide a technical response to fraudulent activities, as described in more detail below. In particular embodiments, one or more the response computers 255 may comprise and/or be in communication with a dilution engine, which can be used to create and/or format a response to a phishing scam. (It should be noted that the functions of the response computers 255 can also be performed by the master computer 210, monitoring computer 220, etc.) In particular embodiments, a plurality of computers (e.g., 255a-c) can be used to provide a distributed response. The response computers 255, as well as the master computer 210 and/or the monitoring computer 220, can be special-purpose computers with hardware, firmware and/or software instructions for performing the necessary tasks. Alternatively, these computers 210, 220, 255 may be general purpose computers having an operating system including, for example, personal computers and/or laptop computers running any appropriate flavor of Microsoft Corp.'s Windows and/or Apple Corp.'s Macintosh operating systems) and/or workstation computers running any of a variety of commercially-available UNIX or UNIX-like operating systems. In particular embodiments, the computers 210, 220, 255 can run any of a variety of free operating systems such as GNU/Linux, FreeBSD, etc.

The computers 210, 220, 255 can also run a variety of server applications, including HTTP servers, FTP servers, CGI servers, database servers, Java servers, and the like. These computers can be one or more general purpose computers capable of executing programs or scripts in response to requests from and/or interaction with other computers, including without limitation web applications. Such applications can be implemented as one or more scripts or programs written in any programming language, including merely by way of example, C, C++, Java, COBOL, or any scripting language, such as Perl, Python, or TCL, or any combination thereof. The computers 210, 220, 255 can also include database server software, including without limitation packages commercially available from Oracle, Microsoft, Sybase, IBM and the like, which can process requests from database clients running locally and/or on other computers. Merely by way of example, the master computer 210 can be an Intel processor-machine operating the GNU/Linux operating system and the PostgreSQL database engine, configured to run proprietary application software for performing tasks in accordance with embodiments of the invention.

In some embodiments, one or more computers 110 can create web pages dynamically as necessary for displaying investigation reports, etc. These web pages can serve as an interface between one computer (e.g., the master computer 210) and another (e.g., the monitoring computer 220). Alternatively, a computer (e.g., the master computer 210) may run a server application, while another (e.g., the monitoring computer 220) device can run a dedicated client application. The server application, therefore, can serve as an interface for the user device running the client application. Alternatively, certain of the computers may be configured as “thin clients” or terminals in communication with other computers.

The system 200 can include one or more data stores, which can comprise one or more hard drives, etc. and which can be used to store, for example, databases (e.g., 230, 235) The location of the data stores is discretionary: Merely by way of example, they can reside on a storage medium local to (and/or resident in) one or more of the computers. Alternatively, they can be remote from any or all of these devices, so long as they are in communication (e.g., via the network 205) with one or more of these. In some embodiments, the data stores can reside in a storage-area network (“SAN”) familiar to those skilled in the art. (Likewise, any necessary files for performing the functions attributed to the computers 210, 220, 255 can be stored a computer-readable storage medium local to and/or remote from the respective computer, as appropriate.)

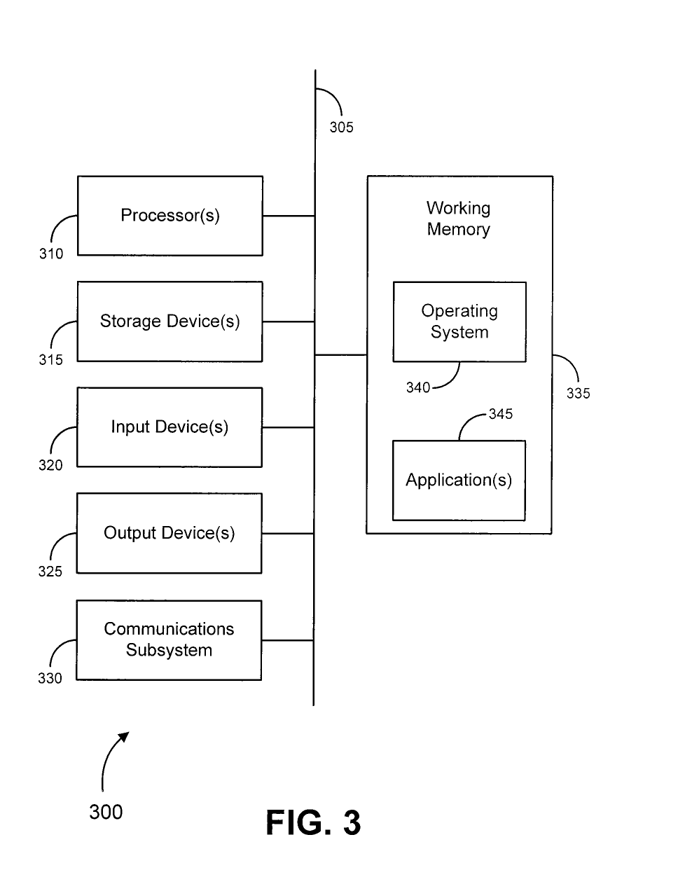

FIG. 3 provides a generalized schematic illustration of one embodiment of a computer system 300 that can perform the methods of the invention and/or the functions of a master computer, monitoring computer and/or response computer, as described herein. FIG. 3 is meant only to provide a generalized illustration of various components, any of which may be utilized as appropriate. The computer system 300 can include hardware components that can be coupled electrically via a bus 305, including one or more processors 310; one or more storage devices 315, which can include without limitation a disk drive, an optical storage device, solid-state storage device such as a random access memory (“RAM”) and/or a read-only memory (“ROM”), which can be programmable, flash-updateable and/or the like (and which can function as a data store, as described above). Also in communication with the bus 305 can be one or more input devices 320, which can include without limitation a mouse, a keyboard and/or the like; one or more output devices 325, which can include without limitation a display device, a printer and/or the like; and a communications subsystem 330; which can include without limitation a modem, a network card (wireless or wired), an infra-red communication device, and/or the like).

The computer system 300 also can comprise software elements, shown as being currently located within a working memory 335, including an operating system 340 and/or other code 345, such as an application program as described above and/or designed to implement methods of the invention. Those skilled in the art will appreciate that substantial variations may be made in accordance with specific embodiments and/or requirements. For example, customized hardware might also be used, and/or particular elements might be implemented in hardware, software (including portable software, such as applets), or both.

As noted above, embodiments of the present invention provide for displaying one or more indicators to the user based on the reputation of a website or other information indicating the relative safety or potential for fraudulent activity related to the site. For example, a browser or other program running on a user's computer, can receive a web page or a URL to a web page and may request reputation information from a monitoring center such as monitoring center 215 described above with reference to FIG. 2. Based on such information, as well as other possible information or criteria, the browser or other program can determine whether the web page is legitimate. Based on this determination, the browser can then display an appropriate indication to the user. Alternatively or additionally, indications of web page reputations can be stored on the user's computer and the indicator shown to the user can be based on this stored “client-side” data elements.

According to one embodiment, when a user installs a browser, upgrades to a browser that supports browser-based indicators, or otherwise performs a set-up function, such as setting user preferences etc., the browser or other application on the user's computer such as, for example, a browser plug-in, can prompt the user to select from a set of indicators for each of one or more types of reputation. For example, the user can be prompted to select an image from a set of pre-defined images or specify user-defined images that correspond to states such as “safe,” “unknown,” and “known fraud.” By allowing the user to select an indicator, either from a set of pre-defined possible indicators or by specifying one or more user-defined indicators, rather than using a default image or images, security is improved since a Phisher, fraudster, or other bad actor is less likely or unable to guess the indicator used by a particular user and then mimic that indicator in an attempt to trick the user into believing a site is safe. Similarly, according to one embodiment, the user could be prompted to select a different image for each of a set of unique legitimate websites so that the user knows that the site is not only legitimate, but the particular legitimate site that they are expecting.

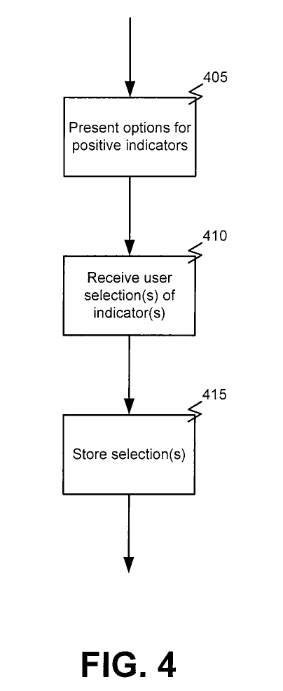

FIG. 4 is a flowchart illustrating a process for selecting one or more indicators according to one embodiment of the present invention. In this example, the process begins with presenting 405 a plurality of options for the at least one indicator during a setup process for the browser. For example, a user may be prompted or guided to select indications via a dialog box or other user interface element having a number of text boxes, checkboxes, radio buttons, and/or other elements. It should be understood that the exact format of the user interface may vary widely depending upon the implementation without departing from the scope of the present invention. In another embodiment, the user can be prompted when he or she visits a site that is known to be legitimate. In such a case, the user can be queried as to whether they want to create two-way authentication on that page. If the user indicates that two-way authentication is desired, they can be prompted to select an indicator as specified in the browser set up scenario above.

Regardless of the exact nature of the user interface, a selection of one or more of the plurality of options can be received 410. The plurality of options can include, for example, a plurality of pre-defined indicators. In such a case, receiving a selection of one or more indicators can comprise receiving a selection of one or more of the pre-defined indicators. In another example, the plurality of options can include an option for specifying one or more user-defined indicators. In such a case, receiving a selection of one or more indicators can comprise receiving an indication of one or more user-defined indicators. In yet another example, the plurality of options can include both a plurality of pre-defined indicators and an option for specifying one or more user-defined indicators. In such a case, receiving a selection of one or more indicators can comprise receiving a selection of one or more of the pre-defined indicators and receiving an indication of one or more user-defined indicators. The user can be prompted to select from a list of either pre-defined indicators or user-defined indicators for every legitimate web site from which the user desires two-way authentication. As noted above, the selections, whether pre-defined or user-defined, can correspond to multiple levels or states such as “safe,” “unknown,” “known fraud,” etc.

According to one embodiment, the user may select a different image for different authenticated sites that the user visits. This may be especially useful for those sites that are visited frequently. According to another alternative, the website may specify a logo that shows that the site the user is visiting is the actual site that was intended. According to yet another embodiment, an overlay of the logo of the verified site can be displayed with the user's chosen image for verified sites. This lets the user know that they have navigated to a site that is not only verified, but it shows them which site is verified.

Once the user's selection or selections have been received, the selections can be stored 415 by the browser or other program for use when viewing or requesting a web page. For example, the selections may be stored as one or more user preference settings or other persistent settings.

Once the images or other indications for each reputation type have been selected by the user, the browser or other program can display the appropriate image for a currently viewed web page in a portion of the browser not accessible or alterable by a web page being displayed, e.g., on the “chrome” of the browser. Based on such an indication, the user can quickly deduce the type of site that they are on and know that the reputation has been confirmed by their particular browser since it is displaying their selected image.

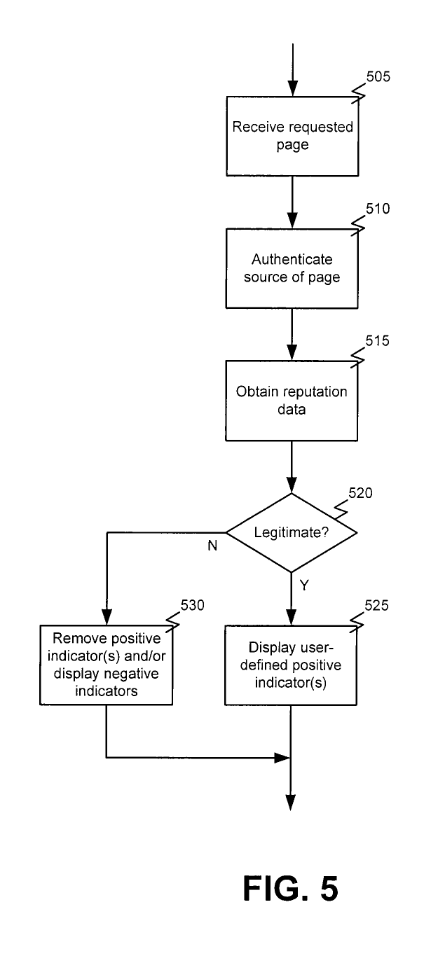

FIG. 5 is a flowchart illustrating a process for providing one or more indicators according to one embodiment of the present invention. In this example, processing begins with receiving 505 the web page. In an alternative embodiment, rather than receiving the web page, the process may begin with a request for a particular URL, i.e., the request for the web page.

According to one embodiment, the source of the web page can be authenticated 510 via any of a variety of possible authentication services and/or methods. Additionally or alternatively, the page can be checked for fraudulent activity and/or legitimacy based on obtaining 515 reputation data related to the page as described above.

A determination 520 can be made as to whether the web page is legitimate or related to possible fraudulent activity. According to one embodiment, determining 520 whether the web page is legitimate can be based on authenticating a source of the web page. Additionally or alternatively, determining whether the web page is legitimate can be based on reputation of the web page.

In response to determining 520 the web page is legitimate, at least one positive indicator can be displayed 525 on a browser window for displaying the web page. Displaying the at least one positive indicator on the browser window can comprise displaying the at least one positive indicator in a portion of the browser window that cannot be modified by the web page, i.e., in the “chrome.” Additionally or alternatively, in response to determining the web page is not legitimate or is related to possible fraudulent activity, the positive indicator, if any, can be removed 530 from the browser window. In such a case, the method can further comprise displaying as least one negative indicator on the browser window.

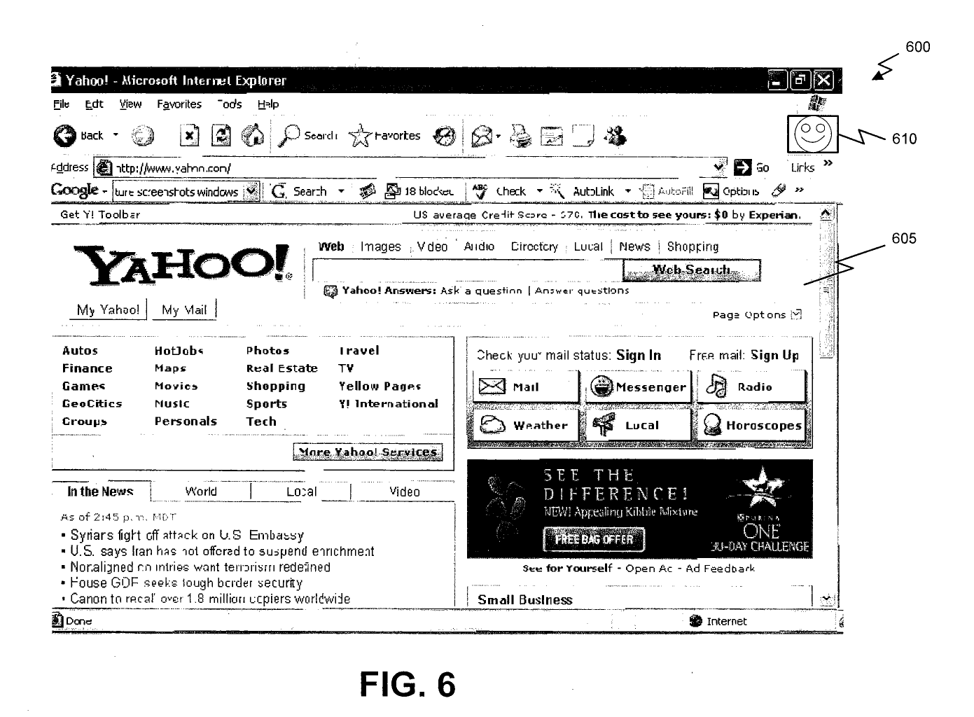

FIG. 6 is an exemplary screenshot of a web browser displaying an indicator according to one embodiment of the present invention. This example illustrates a browser window 600 in which a web page 605 is displayed. Additionally, an indication 610 is also displayed in a portion of the window 600 that cannot be modified by the web page, i.e., in the “chrome” of the browser. It should be noted that, as described above, the indication 610 may be any of a variety of pre-defined and/or user-defined graphics or other indications selected by the user during a set-up operation for the browser. Also, multiple indications, perhaps related to different levels or ratings of possible fraudulent activity may be displayed based on the determinations made by the browser for the web page as described above. Different indicators for unique web sites may also be selected and shown when the user navigates to those sites.

Furthermore, it should be noted that the location, size, and other appearances of the indication 610 can vary depending upon the implementation without departing from the scope of the present invention. However, by placing the indication in a portion to the browser window 600 or on the user's computer desktop that is not alterable by the web page, security can be improved. That is, not only is the ability of the Phisher, fraudster, or other bad actor to guess the indicator used by a particular user inhibited, his ability to mimic an indication is inhibited since the indication does not appear in a portion of the browser window that he can modify via a web page.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of preventing on-line fraud, the method comprising:
receiving a web page;
determining whether the web page is legitimate; and
in response to determining the web page is legitimate, displaying at least one positive indicator.

2. The method of claim 1, wherein displaying at least one positive indicator comprises displaying the at least one positive indicator on a browser window for displaying the web page.

3. The method of claim 1, wherein displaying at least one positive indicator comprises displaying the at least one positive indicator on a desktop display.

4. The method of claim 1, further comprising, in response to determining the web page is not legitimate, removing the positive indicator.

5. The method of claim 4, further comprising displaying at least one negative indicator.

6. The method of claim 2, wherein displaying the at least one positive indicator on the browser window comprises displaying the at least one positive indicator in a portion of the browser window that cannot be modified by the web page.

7. The method of claim 1, wherein determining whether the web page is legitimate is based on authenticating a source of the web page.

8. The method of claim 1, wherein determining whether the web page is legitimate is based on reputation of the web page.

9. The method of claim 1, wherein determining whether the web page is legitimate comprises determining whether the web page is related to possible fraudulent activity.

10. The method of claim 1, further comprising:
presenting a plurality of options for the at least one positive indicator;
receiving a selection of one or more of the plurality of options; and
storing the selection of the one or more of the plurality of options.

11. The method of claim 10, wherein presenting the plurality of options for the at least one positive indicator, receiving the selection of one or more of the plurality of options, and storing the selection of the one or more of the plurality of options is performed during a set-up operation of a web browser.

12. The method of claim 10, wherein presenting the plurality of options for the at least one positive indicator, receiving the selection of one or more of the plurality of options, and storing the selection of the one or more of the plurality of options is performed in response to viewing a known legitimate web page.

13. The method of claim 10, wherein the plurality of options includes a plurality of pre-defined indicators and receiving a selection of one or more indicators comprises receiving a selection of one or more of the pre-defined indicators.

14. The method of claim 10, wherein the plurality of options includes an option for specifying one or more user-defined indicators and receiving a selection of one or more indicators comprises receiving an indication of one or more user-defined indicators.

15. The method of claim 10, wherein the plurality of options includes a plurality of pre-defined indicators and an option for specifying one or more user-defined indicators and receiving a selection of one or more indicators comprises receiving a selection of one or more of the pre-defined indicators and receiving an indication of one or more user-defined indicators.

16. A system comprising:
a processor; and
a memory communicatively coupled with and readable by the processor and having stored therein a series of instructions which, when executed by the processor, cause the processor to receive a web page, determine whether the web page is legitimate, and in response to determining the web page is legitimate, display at least one positive indicator on a browser window for displaying the web page.

17. The system of claim 16, wherein the instructions further cause the processor, in response to determining the web page is not legitimate, to remove the positive indicator from the browser window.

18. The system of claim 17, wherein the instructions further cause the processor to display at least one negative indicator on the browser window.

19. The system of claim 18, wherein displaying the at least one positive indicator on the browser window comprises displaying the at least one positive indicator in a portion of the browser window that cannot be modified by the web page.

20. The system of claim 18, wherein determining whether the web page is legitimate is based on authenticating a source of the web page.

21. The system of claim 18, wherein determining whether the web page is legitimate is based on reputation of the web page.

22. The system of claim 18, wherein the instructions further cause the processor, during a setup process for the browser, to:
present a plurality of options for the at least one positive indicator;
receive a selection of one or more of the plurality of options; and
store the selection of the one or more of the plurality of options.

23. The system of claim 22, wherein the plurality of options includes a plurality of pre-defined indicators and receiving a selection of one or more indicators comprises receiving a selection of one or more of the pre-defined indicators.

24. The system of claim 22, wherein the plurality of options includes an option for specifying one or more user-defined indicators and receiving a selection of one or more indicators comprises receiving an indication of one or more user-defined indicators.

25. The system of claim 22, wherein the plurality of options includes a plurality of pre-defined indicators and an option for specifying one or more user-defined indicators and receiving a selection of one or more indicators comprises receiving a selection of one or more of the pre-defined indicators and receiving an indication of one or more user-defined indicators.

26. A machine-readable medium having stored thereon a series of executable instructions that, when executed by a processor, cause the processor to provide a browser-based indication of legitimacy of a web page by:
receiving the web page;
determining whether the web page is legitimate; and
in response to determining the web page is legitimate, displaying at least one positive indicator.

27. The machine-readable medium of claim 26, further comprising, in response to determining the web page is not legitimate, removing the positive indicator.

28. The machine-readable medium of claim 27, further comprising displaying as least one negative indicator.

29. The machine-readable medium of claim 26, wherein displaying the at least one positive indicator comprises displaying the at least one positive indicator in a portion of a browser window for displaying the web page that cannot be modified by the web page.

30. The machine-readable medium of claim 26, wherein determining whether the web page is legitimate is based on authenticating a source of the web page.

31. The machine-readable medium of claim 26, wherein determining whether the web page is legitimate is based on reputation of the web page.

32. The machine-readable medium of claim 26, wherein determining whether the web page is legitimate comprises determining whether the web page is related to possible fraudulent activity.

33. The machine-readable medium of claim 26, further comprising:
presenting a plurality of options for the at least one positive indicator;
receiving a selection of one or more of the plurality of options; and
storing the selection of one or more of the plurality of options.

34. The machine-readable medium of claim 33, wherein the plurality of options includes a plurality of pre-defined indicators and receiving a selection of one or more indicators comprises receiving a selection of one or more of the pre-defined indicators.

35. The machine-readable medium of claim 33, wherein the plurality of options includes an option for specifying one or more user-defined indicators and receiving a selection of one or more indicators comprises receiving an indication of one or more user-defined indicators.

36. The machine-readable medium of claim 33, wherein the plurality of options includes a plurality of pre-defined indicators and an option for specifying one or more user-defined indicators and receiving a selection of one or more indicators comprises receiving a selection of one or more of the pre-defined indicators and receiving an indication of one or more user-defined indicators.
